(19) United States
(12) Patent Application Publication
(10) Pub. No.: US 2008/0150867 A1
(43) Pub. Date: Jun. 26, 2008

(54) Display Device and Electric Apparatus Using the Same

(76) Inventors: Akio Miyata, Nara (JP); Shinichi Nakano, Nara (JP); Junichi Tanaka, Nara (JP); Shuichi Kozaki, Nara (JP)

Correspondence Address: NIXON & VANDERHYE, PC, 901 NORTH GLEBE ROAD, 11TH FLOOR, ARLINGTON, VA, 22203, US

(21) Appl. No.: 11/795,493

(22) PCT Filed: Mar. 29, 2006
(86) PCT No.: PCT/JP06/06406

§ 371 Date: Jul. 18, 2007

(30) Foreign Application Priority Data
Mar. 29, 2005 (JP) 2005-095545

(51) Int. Cl. G09G 3/36

(52) U.S. Cl. 345/93

(57) ABSTRACT

An upper electrode substrate that is provided on a display surface side; and a reflecting sheet (back surface sheet) that is provided on a back surface side of the upper electrode substrate such that an upper space (display space) is formed between the upper electrode substrate and the reflecting sheet, and such that a through hole (liquid storage space) whose one end side is connected with the upper space is formed; are provided. Moreover, an upper electrode (first electrode) is provided on an upper side and a lower side of the upper space, a lower electrode (second electrode) is provided so as to surround the through hole, and the upper electrode and the lower electrode are connected to a switch (driver) and an alternating-current power supply (driver). An upper electrode substrate 12 that is provided on a display surface side; and a reflecting sheet (back surface sheet) 10 that is provided on a back surface side of the upper electrode substrate 12 such that an upper space (display space) 11 is formed between the upper electrode substrate 12 and the reflecting sheet 10, and such that a through hole (liquid storage space) 15 whose one end side is connected with the upper space 11 is formed; are provided. Moreover, an upper electrode (first electrode) 30 is provided on an upper side and a lower side of the upper space 11, a lower electrode (second electrode) 32 is provided so as to surround the through hole 15, and the upper electrode 30 and the lower electrode 32 are connected to a switch (driver) 35 and an alternating-current power supply (driver) 36.

### TECHNICAL FIELD

The present invention relates to a display device that utilizes an electrowetting phenomenon to move a liquid, thereby displaying information such as images and characters, and an electric apparatus using the same.

### BACKGROUND ART

Conventionally, display devices that display information by utilizing a moving phenomenon of a transparent or colored liquid have been suggested. For example, display devices that utilize an external electric field to move a liquid, thereby displaying information, include those of an electroosmosis system and of an electrowetting system.

In the display devices of the electroosmosis system, a liquid impregnation rate of a surface of a porous body is controlled so as to scatter external light, whereby a light reflectance and a light transmittance thereof with respect to the external light are controlled. Also, these display devices of the electroosmosis system have a configuration in which the porous body and the transparent liquid that have an equal refractive index are prepared in advance so as to achieve transparency by filling the liquid in through holes (small holes) in the porous body and cause light to be scattered by allowing the liquid to flow out from the through holes.

In the display devices of the electrowetting system, an electric field is applied to a liquid inside small pores so as to vary an interfacial tension of the liquid, thus causing this liquid to move by an electrocapillary phenomenon (an electrowetting phenomenon). More specifically, when a switch between a pair of electrodes provided on an inner surface of a small hole is dosed so as to apply an electric field to the liquid, a wettability of the liquid with respect to the inner surface of the small hole varies. Accordingly, a contact angle of the liquid with respect to the inner surface of the small hole decreases, so that the liquid moves inside the small hole. On the other hand, when the switch is opened to stop the application of electric field to the liquid, the wettability of the liquid with respect to the inner surface of the small hole varies, thus increasing the contact angle sharply, so that the liquid flows out from the small hole.

In order to display moving images in the display devices described above, the liquid has to be moved inside the small hole at a high speed and at a low voltage. When the electroosmosis system and the electrowetting system are compared in this respect, the electrowetting system is more suitable for displaying moving images because it can move the liquid at a higher speed.

Further, using the conventional display devices, image displays utilizing the electrowetting phenomenon are provided as described in Patent Document 1 described below, for example.

More specifically, as shown in FIG. 9, a display device according to the above-noted conventional example is constituted of transparent sheets, and includes a first sheet 1, a second sheet 2 and a third sheet 3 that are arranged in this order from an upper side of FIG. 9 (a display surface side) with predetermined gaps therebetween. An upper side passage 4 is provided between the first sheet 1 and the second sheet 2, and a lower side passage 5 is provided between the second sheet 2 and the third sheet 3. Also, the second sheet 2 is provided with reservoirs 6 and 7 that allow the upper side passage 4 and the lower side passage 5 to communicate with each other. Furthermore, inside the upper side passage 4, the lower side passage 5, the reservoirs 6 and 7, a conductive liquid L1 that is colored in a predetermined color and a transparent liquid L2 that is transparent are sealed.

Moreover, in this display device according to this conventional example, first electrodes 8A and 8B respectively are disposed on a lower surface side of the first sheet 1 and an upper surface side of the second sheet 2 so as to sandwich the upper side passage 4. Also, inside the upper side passage 4, a second electrode 9 is disposed at a position opposed to an upper end opening of the reservoir 6. The first electrodes 8A, 8B and the second electrode 9 are connected to a direct current power supply as shown in FIG. 9, thereby making it possible to apply an electric field to the conductive liquid L1.

In the display device according to the conventional example having the above-described configuration, a circuit between the first electrodes 8A, 8B and the second electrode 9 is closed to apply a voltage between these electrodes, thereby both moving the transparent liquid L2 inside the upper side passage 4 to a side of the lower side passage 5 and moving the conductive liquid L1 from a side of the reservoir 6 to a side of the upper side passage 4 so as to cause the above-mentioned predetermined color to be present on the display surface side.

On the other hand, the above-described circuit is opened, thereby both returning the conductive liquid L1 from the side of the upper side passage 4 to the side of the reservoir 6 and moving the transparent liquid L2 from the side of the reservoir 7 to the side of the upper side passage 4, so that the transparent display is achieved on the display surface side.

Patent document 1: JP 10(1998)-39799 A

### DISCLOSURE OF INVENTION

### Problem to be Solved by the Invention

However, in the conventional display device as described above, the upper side passage 4 is provided between the first sheet 1 and the second sheet 2, and the lower side passage 5 is provided between the second sheet 2 and the third sheet 3. Further, in the conventional display device, plural reservoirs 6 and 7 are provided in the second sheet 2 such that the upper side passage 4 and the lower side passage 5 are connected with each other. Thus, since the device structure of this conventional display device is complicated, it is difficult to decrease a thickness thereof, so that it is difficult to achieve a compact display device.

Moreover, in the conventional display device, since the first electrode 8A and the second electrode 9 are provided on the side of the upper side passage (display space) 4, the electric field to be applied to the conductive liquid L1 in the reservoir 6 cannot be increased, so that it is difficult to increase a moving speed of the conductive liquid L1 to the side of the upper side passage 4.

As described above, the conventional display device has a problem in that the moving speed of the conductive liquid cannot be increased with a simple configuration.

In the light of the above-described problem, it is an object of the present invention to provide a compact display device that can increase the moving speed of the conductive liquid with a simple configuration, and an electronic apparatus using the same.

### Means for Solving Problem

In order to attain the above-described object, the display device of the present invention includes: a transparent sheet provided on a display surface side; a back surface sheet provided on a back surface side of the transparent sheet such that a predetermined display space is formed between the transparent sheet and the back surface sheet, and such that a liquid storage space whose one end side is connected with the display space is formed; a transparent first electrode provided on a surface side of at least one of the transparent sheet and the back surface sheet on the display space side; a second electrode provided in the back surface sheet so as to surround the liquid storage space; a conductive liquid sealed into an inside of a liquid flowing part formed of the display space and the liquid storage space so as to be movable toward the display space side or the liquid storage space side; and a driver having a switch and a power supply connected between the first electrode and the second electrode, and for changing a display color on the display surface side by moving the conductive liquid toward the display space side or the liquid storage space side according to operations of opening/closing the switch.

In the display device with the above-described configuration, the display space is formed between the transparent sheet and the back surface sheet, the liquid storage space that is connected with the display space is provided in the back surface sheet, and the conductive liquid is sealed inside the fluid flowing part formed of the display space and the liquid storage space. Moreover, the driver moves the conductive liquid toward the display space side or the liquid storage space side according to the operations of opening/closing the switch that is connected between the first electrode and the second electrode, and thereby to change the display color on the display surface side. Thereby, unlike the above-described conventional example, the complication of the device structure can be prevented, and a thickness thereof can be reduced, so that a compact display device can be achieved. Moreover, since the first electrode is provided on the surface side of the display space side, and the second electrode is provided on the back surface sheet side, an electric field can be applied to the conductive liquid swiftly, thereby increasing the moving speed of the conductive liquid.

Moreover, in the display device, it is preferable that the first electrode is provided so as to cover the display surface side of the display space.

In this case, the electric field to be applied to the conductive liquid can be increased easily, so that the moving speed of the conductive fluid can be increased easily.

Moreover, in the display device, it is preferable that the second electrode is provided on a surface, which faces the liquid storage space, of the back surface sheet.

In this case, the electric field to be applied to the conductive liquid can be increased easily, so that the moving speed of the conductive fluid can be increased easily.

Moreover, in the display device, it is possible that one end side of the liquid storage space is connected with a central portion of the display space.

In this case, the movement of the conductive liquid from the liquid storage space toward a peripheral portion side of the display space, and the movement of the conductive liquid from the peripheral portion of the display space toward the liquid storage space side can be performed at a uniform speed.

Moreover, in the display device, it is also possible that one end side of the liquid storage space is connected with one end portion of the display space.

In this case, the movement of the conductive liquid toward the display space side or the liquid storage space side can be performed smoothly.

Moreover, in the display device, it is preferable that a dielectric layer is laminated on a surface of the first electrode or the second electrode on the display space side.

In this case, the dielectric layer securely increases the electric field to be applied to the conductive liquid, so that the moving speed of the conductive fluid can be increased more easily.

Moreover, in the display device, the back surface sheet may include: an intermediate sheet whose one surface is provided on the display space side, and which has a through hole whose one end side is connected with the display space so as to constitute the liquid storage space; and a substrate sheet that is provided on a back surface side of the intermediate sheet so as to seal the other end side of the through hole.

In this case, since the back surface sheet is structured to include the intermediate sheet and the substrate sheet, a structural strength of the display device can be increased easily. Moreover, the liquid storage space is constituted of the through hole, and thus can be formed with higher precision.

Moreover, in the display device, it is preferable that the second electrode is provided in the substrate sheet so as to close the other end side of the through hole.

In this case, the electric field to be applied to the conductive liquid can be increased more easily, so that the moving speed of the conductive fluid can be increased more easily.

Moreover, in the display device, it is also possible that the conductive liquid is made of a colored liquid that is colored in a predetermined color, a transparent insulating fluid that does not blend in the conductive liquid is sealed into the inside of the liquid flowing part so as to be movable toward the display space side or the liquid storage space side, the intermediate sheet is constituted of a reflecting sheet, and the driver moves the conductive liquid and the insulating fluid toward the display space side and the through hole side, respectively, so as to change the display color on the display surface side into the predetermined color, and moves the insulating fluid and the conductive liquid toward the display space side and the through hole side, respectively, so as to change the display color on the display surface side into white.

In this case, the reflecting sheet reflects external light that is incident from an outside so as to achieve white display, so that display quality of the white display can be improved easily.

Moreover, in the display device, it is preferable that the reflecting sheet includes: a transparent polymeric resin; and plural kinds of fine particles that are added into an inside of the polymeric resin and have different refractive indices.

In this case, the reflecting sheet securely causes the light to be scattered due to the difference between the refractive indices of the plural kinds of the fine particles, so that the display quality of the white display can be improved more easily.

Moreover, in the display device, it is also possible that the conductive liquid is made of a colored liquid that is colored in a predetermined color, a transparent insulating fluid that does not blend in the conductive liquid is sealed into the inside of the liquid flowing part so as to be movable toward the display space side or the liquid storage space side, the intermediate sheet and the substrate sheet is constituted of a transparent sheet, a back light is provided on a back surface side of the substrate sheet, and the driver moves the conductive liquid and the insulating fluid toward the display space side and the through hole side, respectively, so as to change the display color on the display surface side into the predetermined color, and moves the insulating fluid and the conductive liquid toward the display space side and the through hole side, respectively, so as to change the display color on the display surface side into white.

In this case, the white display is achieved by illumination light from the back light, so that the display quality of the white display can be improved easily. Further, because of using the back light, the display operation can be performed even when the external light is not sufficient.

Moreover, in the display device, it is also possible that the conductive liquid is made of a colored liquid that is colored in a predetermined color, a transparent insulating fluid that does not blend in the conductive liquid is sealed into the inside of the liquid flowing part so as to be movable toward the display space side or the liquid storage space side, the intermediate sheet includes a reflecting sheet and a transparent sheet that are provided in parallel, the substrate sheet is constituted of a transparent sheet, a back light is provided on a back surface side of the substrate sheet, and the driver moves the conductive liquid and the insulating fluid toward the display space side and the through hole side, respectively, so as to change the display color on the display surface side into the predetermined color, and moves the insulating fluid and the conductive liquid toward the display space side and the through hole side, respectively, so as to change the display color on the display surface side into white.

In this case, since the white display is achieved by the reflecting sheet and illumination light from the back light, so that the display quality of the white display can be improved easily. Further, since the external light is used besides the back light, power consumption of the back light can be saved.

Moreover, in the display device, it is also possible that light-scattering particles are mixed into the conductive liquid, a transparent insulating fluid that does not blend in the conductive liquid is sealed into the inside of the liquid flowing part so as to be movable toward the display space side or the liquid storage space side, a colored layer in a predetermined color is provided on a surface side of the intermediate sheet on the display space side, and the driver moves the conductive liquid and the insulating fluid toward the display space side and the through hole side, respectively, so as to change the display color on the display surface side into white, and moves the insulating fluid and the conductive liquid toward the display space side and the through hole side, respectively, so as to change the display color on the display surface side into the predetermined color.

In this case, the white display is achieved by the light-scattering particles that are mixed with the conductive liquid, so that the display quality of the white display can be improved easily.

Moreover, in the display device, it is preferable that a plurality of the display spaces are provided respectively for a plurality of colors allowing a full color display on the display surface side.

In this case, the driver moves the corresponding conductive liquid properly in each of the plurality of the display spaces, so that color images can be displayed.

Moreover, the electric apparatus of the present invention includes a display portion for displaying information containing a character and an image, and any one of the display devices described above is used for the display portion.

In the electric apparatus with the above-described configuration, since the compact display device that can increase the moving speed of the conductive liquid with the simple structure is used as the display portion, the moving image can be displayed, thus easily structuring the electric apparatus provided with the compact display portion that has an excellent displaying function.

### EFFECTS OF THE INVENTION

According to the present invention, a compact display device that can increase a moving speed of a conductive liquid with a simple structure, and an electric apparatus using the same can be provided.

### BRIEF DESCRIPTION OF DRAWINGS

FIG. 1 is a cross-sectional view showing a configuration of a main part of a display device and an image display according to Embodiment 1 of the present invention.

FIG. 2 is a view for explaining a state of an operation of the display device and the image display in a case where the switch shown in FIG. 1 is OFF.

FIG. 3 is a cross-sectional view showing a configuration of a main part of a display device and an image display according to Embodiment 2 of the present invention.

FIG. 4 is a cross-sectional view showing a configuration of a main part of a display device and an image display according to Embodiment 3 of the present invention.

FIG. 5 is a cross-sectional view showing a configuration of a main part of a display device and an image display according to Embodiment 4 of the present invention.

FIG. 6 is a cross-sectional view showing a configuration of a main part of a display device and an image display according to Embodiment 5 of the present invention.

FIG. 7A is a cross-sectional view showing a configuration of a main part of a display device and an image display according to Embodiment 6 of the present invention, and FIG. 7B is a view for explaining a state of an operation of the display device and the image display according to Embodiment 6 in a case where the switch shown in FIG. 7A is OFF.

FIG. 8 is a cross-sectional view showing a configuration of a main part of a display device and an image display according to Embodiment 7 of the present invention.

FIG. 9 is a cross-sectional view showing a configuration of a main part of a conventional display device and a conventional image display.

### DESCRIPTION OF THE INVENTION

The following is a description of preferred embodiments of a display device and an electric apparatus according to the present invention, with reference to the accompanying drawings. In the description below, a case of applying the present invention to an image display including a display portion capable of displaying a color image will be illustrated.

### Embodiment 1

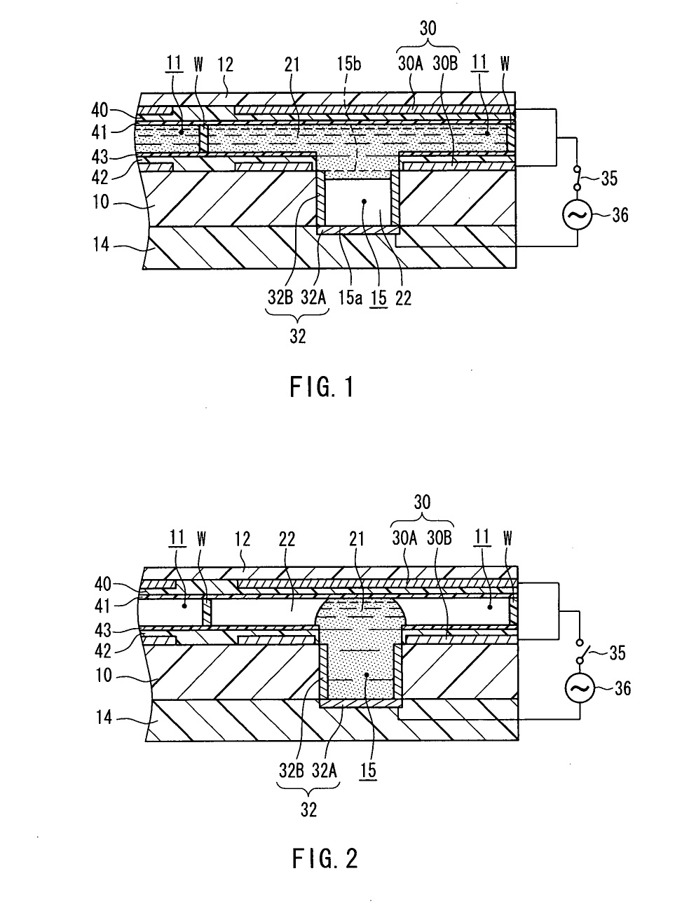

FIG. 1 is a cross-sectional view showing a configuration of a main part of a display device and an image display according to Embodiment 1 of the present invention, and FIG. 2 is a view for explaining a state of an operation of the display device and the image display in a case where the switch shown in FIG. 1 is OFF.

In FIGS. 1 and 2, the image display according to the present embodiment is provided with a display portion constituted of the display device according to the present invention. In this display portion, an upper side in the figure corresponds to a display surface side recognized visually by a user. The above-noted display device includes a reflecting sheet 10 for scattering external light from the display surface side so as to display white, an upper electrode substrate 12 provided on a display surface side of the reflecting sheet 10 such that a rectangular upper space 11 is formed between the reflecting sheet 10 and the upper electrode substrate 12, and a lower electrode substrate 14 provided on a lower side of the reflecting sheet 10. The upper electrode substrate 12 is formed of a transparent insulating material, and constitutes a transparent sheet that is provided on the display surface side. Moreover, the reflecting sheet 10 and the lower electrode substrate 14 are formed of an insulating material and respectively constitute an intermediate sheet and a substrate sheet, and are included in a back surface sheet that is provided on the back surface side of the transparent sheet. Further, the display device on the display surface side is partitioned off by a plurality of partition walls W, so that a plurality of pixel regions are formed in a transverse direction of the figure and a direction perpendicular to the paper surface of the figure. Moreover, in the display device, the pixel regions for individual colors of R, G and B are provided so as to be adjacent to one another as a single picture element, for example, thus allowing a full-color display on the above-noted display surface side.

In a central portion of each of the pixel regions of the reflecting sheet 10, a through hole 15 penetrating the reflecting sheet 10 in its thickness direction (the vertical direction in the figures) is provided. This through hole 15 constitutes a liquid storage space, and one end thereof is connected with the upper space 11 constituting a display space. In other words, a lower end opening 15a of the through hole 15 is positioned on a surface of the lower electrode substrate 14, and is closed airtightly by a below-described lower electrode 32A. Whereas, an upper end opening 15b is formed such that the through hole 15 is connected with a central portion of the upper space 11, and a liquid flowing part having a T-shaped cross-section is constituted of the through hole 15 and the upper space 11 for each pixel.

In the above-described liquid flowing part, a coloring ion conductive liquid that does not contain water (hereinafter, abbreviated as a conductive liquid) 21 and an insulating oil 22 are sealed. Moreover, in the two adjacent liquid flowing parts that are partitioned off by the partition wall W, conductive liquids 21 that are colored in different colors are sealed respectively. That is, a colorant of either R, G or B such as a pigment or a dye is added to the conductive liquid 21, and a display color on the display surface side that corresponds to the color of R, G or B can be displayed.

Moreover, the conductive liquid 21 is not limited to an ionic liquid, but the ionic liquid is used preferably in the light of a vapor pressure of 0, excellent thermal stability and a high conductivity.

More specifically, the conductive liquid 21 is an ambient temperature molten salt formed of a 1-1 salt obtained by combining one kind of monovalent cation and one kind of monovalent anion, and is an ionic conductive liquid that contains no water.

The cation is selected from the group consisting of 1,3-dialkylimidazolium cation, N-alkylpyridinium cation, tetraalkylammonium cation and tetraalkylphosphonium cation.

Furthermore, the anion may be selected from the group consisting of (AlCl₃)nCl⁻, (AlBr₃)nBr⁻, Cl⁻, Br⁻, I⁻, (HF)nF⁻, BF₄⁻, PF₆⁻, TaF₆⁻, WF₇⁻, NO₃⁻, NO₂⁻, CF₃SO₃⁻, (CF₃SO₂)₂N⁻, (CF₃SO₂)₃C⁻, (CF₃CF₂SO₂)N⁻, CF₃COO⁻, CF₃CF₂CF₂CO⁻, CF₃CF₂CF₂SO₃⁻, (CN)₂N⁻ and CH₃COO⁻.

The combination of the cation and the anion are selected such that the conductive liquid 21 has a melting point, a viscosity and an ionic conductivity described below.

The conductive liquid 21 has a melting point of −4° C. to −90° C., is liquid at room temperature, is nonvolatile and thus has a vapor pressure of 0, and has a wide liquid temperature region and excellent thermal stability.

The ionic conductivity (s/cm) thereof is equal to or larger than 0.1×10⁻^{₃} at room temperature (25° C.).

The viscosity thereof is equal to or smaller than 300 cp at room temperature (25° C.).

The conductive liquid having the above-mentioned physical properties can contain chemical species of 1-ethyl-3-methylimidazolium, 1-butyl-3-methylimidazolium or dimethyl-3-propylimidazolium noted above.

The oil 22 has a physical property of not mixing with the conductive liquid 21. As the oil 22, a nonpolar oil that contains one or plural kinds selected from the group consisting of side-chain higher alcohol, side-chain higher fatty acid, alkane, a silicone oil and a matching oil that are transparent is used.

Also, in the display device, for the purpose of applying a voltage to or removing a voltage from the conductive liquid 21 so as to move the conductive liquid 21 and replace it with the oil 22, the upper electrode 30 as the transparent first electrode is provided on a surface side of the upper space 11 side. More specifically, on a lower surface of the upper electrode substrate 12, an upper-side upper electrode 30A is provided so as to cover the display surface side of the upper space 11. Moreover, on the reflecting sheet 10 side, a lower-side upper electrode 30B is provided on surfaces facing the upper space 11 except the opening of the through hole 15. These upper electrodes 30A and 30B are transparent electrodes using ITO films or the like, and are connected electrically to each other.

Whereas, in the reflecting sheet 10 and the lower electrode substrate 14, the lower electrode 32 as the second electrode is provided so as to surround the through hole 15. More specifically, on an upper surface of the lower electrode substrate 14, the lower-side lower electrode 32A is provided so as to close the lower end opening 15a of the through hole 15. Moreover, in the reflecting sheet 10, the cylindrical lower electrode 32B is provided on the surfaces facing the through hole 15, and these lower electrodes 32A and 32B are connected electrically to each other. Further, the lower electrode 32A is a transparent electrode using an ITO film or the like. Moreover, the lower electrode 32B is an electrode made of a metal such as aluminum or copper, and is formed by a vacuum evaporation method, a sputtering method, an ion plating method, a dip coating method or the like.

Moreover, the upper electrode 30 and the lower electrode 32 are connected to an alternating-current power supply 36 via a switch 35, and the application of the electric field to the conductive liquid 21 is performed and stopped according to the operations of closing/opening the switch 35. Also, the switch 35 and the alternating-current power supply 36 constitute a driver for changing a display color on the display surface side by moving the conductive liquid 21 toward the upper space 11 side or the through hole 15 side according to the operations of closing/opening the switch 35, and the conductive liquid 21 is moved by the electrowetting phenomenon.

The surfaces of the upper electrodes 30A and 30B are provided with dielectric layers 40 and 42, respectively. Also, the surfaces of the dielectric layers 40 and 42 are provided with insulating water-repellent films 41 and 43, respectively, which are in contact with the conductive liquid 21 or the oil 22.

The dielectric layers 40 and 42 are formed of a high dielectric film containing parylene or aluminum oxide, for example, and have a thickness of about 1 μm to 0.1 μm. Also, the water-repellent films 41 and 43 preferably become layers having an affinity for the conductive liquid 21 at the time of applying a voltage. More specifically, a fluorocarbon resin is preferable.

Alternatively to the above description, the surface of the lower electrode 32 also can be provided with a coating that becomes lipophilic in an ON (closed) state of the switch 35 and becomes lipophobic in an OFF (opened) state of the switch 35, thereby improving a moving speed of the oil 22 at the time of the operations of closing/opening the switch 35, so that the moving speed of the conductive liquid 21 can be raised as well. However, as shown in FIGS. 1 and 2, it is more preferable that the conductive liquid 21 is constantly in contact with a part of the lower electrode 32 regardless of the operations of closing/opening the switch 35 so as to apply the voltage to this conductive liquid 21 directly, because the moving speed of the conductive liquid 21 can be improved easily.

The reflecting sheet 10 contains a transparent polymeric resin and plural kinds of fine particles that are added into the polymeric resin and have different refractive indices. Thus, when the conductive liquid 21 flows out from the inside of the upper space 11 and the transparent oil 22 flows into the upper space 11, it is possible to display the display surface in white like a paper. More specifically, in the reflecting sheet 10, the above-noted polymeric resin can be a thermoplastic resin or a thermosetting resin, for example, an epoxy resin, an acrylic resin, a polyimide resin, a polyamide resin, polycarbonate, Teflon (registered trademark) or the like. Also, in the reflecting sheet 10, fine particles of titanium oxide or alumina having a large refractive index and hollow polymer fine particles having a small refractive index are contained as the above-noted plural kinds of fine particles. They cause diffusion on the surface of the reflecting sheet 10, making it possible to achieve a color of white like a paper.

Alternatively to the above description, a reflecting sheet using glass, ceramic or the like can also be used.

Further, the above-described through hole 15 has a diameter of about 0.1 μm to 100 μm, and can raise the intensity of the electric field generated in the through hole 15 in the ON state of the switch 35. This makes it possible to increase the moving speed of the conductive liquid 21 moving from the inside of the through hole 15 and ejecting toward the upper space 11 side by the electrowetting phenomenon.

Moreover, the reflecting sheet 10 has a thickness of preferably about 10 μm to 300 μm, more preferably 10 μm to 100 μm and particularly preferably about 50 μm. By setting the thickness of the reflecting sheet 10 to be very small, which is equal to or smaller than 1 mm, as above, it becomes possible to achieve a so-called paper display easily.

When the reflecting sheet 10 is set to have a thickness of 10 μm to 300 μm, the length of the through hole 15 in the vertical direction in the figure also is 10 μm to 300 μm. Thus, the conductive liquid 21 can be flown in and out of the through hole 15 having a diameter of 0.1 μm to 100 μm and a length of 10 μm to 300 μm at a high speed by the electrowetting phenomenon.

The through hole 15 can be formed by a suitable method such as a photolithography method, an anodic oxidation method, an etching method, a dyeing method or a printing method.

The upper electrode substrate 12 and the lower electrode substrate 14 are formed of a transparent resin sheet similar to the reflecting sheet 10 so as to have a thickness of 10 μm to 300 μm. Also, the upper space 11 has a gap of 5 μm to 50 μm, preferably about 10 μm in the vertical direction of the figure. It should be noted that this gap is the dimension between the water-repellent films 41 and 43.

Herein, specific processes of manufacturing the display device in the present embodiment will be described.

As the reflecting sheet 10 constituting a light-scattering structure, a reflecting sheet (with a thickness of 75 μm) produced by FUJICOPIAN CO., LTD. was used. This reflecting sheet 10 was made of a material obtained by kneading a PET resin with fine particles of titanium oxide so that white was achieved by the titanium oxide.

After SiO₂ films as buffer layers (surface reforming films) were deposited on the surfaces of the reflecting sheet 10 by the sputtering method, ITO films as transparent electrodes were deposited by the sputtering method, thus forming the upper electrode 30B on the lower side of the upper space 11. The SiO₂ films had a thickness of 30 nm, and the ITO films had a thickness of 100 nm.

The reflecting sheet 10 was provided with the through holes 15 having a diameter of 30 μmφ and a depth of 75 μm by an excimer laser processing using a mask with a large number of apertures. Incidentally, it was also possible to form the through holes by a micro-drill processing instead of the excimer laser processing.

A parylene film was formed on the ITO film surfaces on the upper surface of the reflecting sheet 10 provided with the through holes 15 by a vapor deposition method, thus forming the dielectric layer 42 having a thickness of 1 μm. Furthermore, the water-repellent film 43 produced by Fluoro Technology was formed on the surfaces of the dielectric layer 42 by a dipping method. After the formation, it was burned at 80° C. for 30 minutes. This water-repellent film 43 had a thickness of 20 nm.

In order to form the lower electrode 32B around the through holes 15 in the reflecting sheet 10, an oblique deposition method was employed. More specifically, a metal electrode material such as aluminum or tantalum was deposited so as to provide a desired thickness by the oblique deposition method.

The upper electrode substrate 12 was formed of a transparent PET resin, and on its surface facing the upper space 11, the upper electrode 30A formed of an SiO₂ film and an ITO film, the dielectric layer 40 formed of a parylene film and the water-repellent film 41 were formed in this order similarly to the reflecting sheet 10. Moreover, the lower electrode substrate 14 was formed of a transparent PET resin, and the lower electrode 32A formed of an SiO₂ film and an ITO film was formed at the position of the lower end opening of the through hole 15.

Thereafter, the lower electrode substrate 14 and the reflecting sheet 10 were adhered by a UV curable adhesive. Then, in order to form the upper space 11 having a gap of 10 μm between the upper electrode substrate 12 and the reflecting sheet 10, a resin spacer of 10 μm in width and 10 μm in height was formed. Subsequently, a white UV curable resin was applied to a peripheral portion of each of the pixels using an ink jet method or a printing method and was cured by ultraviolet light, thereby forming white partition walls W so that the conductive liquids 21 colored in predetermined colors of any of R, G and B were not mixed with each other.

Then, a nonaqueous conductive liquid (produced by Koei Chemical Co., Ltd.; trade name: IL-A4) 21, which was an ambient temperature molten salt made of aliphatic amine, and an oil (n-dodecane; produced by Kishida Chemical Co., Ltd.) 22 were filled into the through holes 15 using a microcapillary falling-drop method. Thereafter, by adding a predetermined pigment to the conductive liquid 21, the conductive liquid 21 was colored in any of R, G and B.

After attaching the upper electrode substrate 12 to an upper surface of the partition wall W, they are adhered by the UV curable adhesive, thereby manufacturing a display cell.

Subsequently, the upper electrode 30 and the lower electrode 32 were connected to the alternating-current power supply 36 via the switch 35, thereby completing the display device. A voltage to be applied was an alternating voltage of 40 V to 100 V at a frequency of 10 kHz. Moreover, the display device was set under an optical microscope connected to a high-speed camera, and the state of the operations of the display device was observed during the operations of opening/closing the switch 35 of the above-described driver. That is, when the switch 35 was turned ON in a state where the conductive liquid 21 and the oil 22 were introduced into the insides of the through holes 15 and the upper space 11, respectively, the conductive liquid 21 was ejected from the through holes 15 and spread out in the upper space 11. On the other hand, when the switch 35 was turned OFF, it was possible to confirm the operation in which the conductive liquid 21 returned to the insides of the through holes 15 and was replaced with the oil 22.

The following is a specific description of the operation of the display device of the present embodiment having the above-described configuration.

As shown in FIG. 2, in the display device, when the switch 35 is in an OFF state, the conductive liquid 21 is present inside the through holes 15, so that the display surface side is allowed to display white by the reflecting sheet 10.

Then, as shown in FIG. 1, when the switch 35 is turned ON, the conductive liquid 21 moves from the through hole 15 side toward the upper space 11 side, and the display surface side displays a color resulting from the conductive liquid 21.

More specifically, when the switch 35 is turned ON, the wettability of the conductive liquid 21 with respect to the surfaces of the water-repellent films 41 and 43 on the upper space 11 side of the upper electrode 30 supplied with a voltage varies, thus decreasing an interfacial tension and a contact angle between the conductive liquid 21 and the above-noted surfaces. Accordingly, the conductive liquid 21 is drawn by an external tension, which has increased relatively, is moved from the through hole 15 side toward the upper space 11 side and spreads out inside the upper space 11.

On the other hand, when the switch 35 is turned OFF, the voltage is removed from the upper electrode 30. Then, the external tension with respect to the conductive liquid 21 returns to an intrinsic interfacial tension of the conductive liquid 21 itself, so that the conductive liquid 21 is drawn toward the through holes 15 and returns to the insides of the through holes 15.

At the time of moving the conductive liquid 21 between the upper space 11 and the through hole 15 by the voltage control of switching between applying and removing the voltage as described above, the oil 22 is moved to a position replaced with the conductive liquid 21.

In other words, when the conductive liquid 21 in the upper space 11 moves toward the through hole 15 side, the oil 22 in the through hole 15 goes up from the inside of the through hole 15 and flows in toward the upper space 11 side. Conversely, when the conductive liquid 21 in the through hole 15 moves toward the upper space 11 side, the oil 22 in the upper space 11 goes down from the upper space 11 and returns to the through hole 15 side.

In this manner, by turning ON the switch 35 so as to allow the conductive liquid 21 to be present in the upper space 11 while the voltage is applied to the upper electrode 30, a color resulting from the conductive liquid 21 can be displayed on the display surface side. On the other hand, by turning OFF the switch 35 so as to allow the conductive liquid 21 to return from the upper space 11 to the through hole 15 side while the voltage is not applied to the upper electrode 30, the conductive liquid 21 is replaced with the transparent oil 22 inside the upper space 11. Thus, the upper surface (light-scattering surface) of the reflecting sheet 10 is exposed to the display surface side, thereby displaying white. Moreover, the above-described light-scattering structure that reflects external light is used in the reflecting sheet 10, and the light is securely scattered due to the difference between the refractive indices of the plural kinds of the fine particles included in the reflecting sheet 10, thereby improving the display quality of the white display more easily.

Moreover, as described above, the display device is partitioned by the partition wall W for each pixel, and the above-described driver can move the conductive liquid 21 toward the upper space 11 side or the through hole 15 side in each pixel. Accordingly, in the display device, each of the colors of R, G and B is displayed by allowing the conductive liquid 21 that is colored in the corresponding color to flow into the upper space 11 side. Further, in the respective adjacent pixels of R, G and B, all of the conductive liquids 21 flow into the corresponding upper spaces 11 so as to absorb all of external light, so that the display surface side can display black.

According to the present embodiment with the above-described configuration, the upper space (display space) 11 is formed between the upper electrode substrate (transparent sheet) 12 and the reflecting sheet (intermediate sheet) 10. Moreover, the through hole Liquid storage space) 15 that is connected with the upper space 11 is provided in the reflecting sheet 10, so that the conductive liquid 21 is sealed into an inside of a fluid flowing part having a T-shaped cross section, which is constituted of the upper space 11 and the through hole 15. Moreover, by moving the conductive liquid 21 toward the upper space 11 side or the through hole 15 side according to the operations of opening/closing the switch (driver) 35, thereby changing the display color on the display surface side. Thereby, unlike the above-described conventional example, the device structure can be prevented from being complicated, and the thickness can be decreased, thereby achieving a compact device.

Moreover, in the present embodiment, since the upper electrodes (first electrodes) 30 are provided on the respective surface sides of the upper electrode substrate 12 and the reflecting sheet 10 on the upper space 11 side, and the lower electrode (second electrode) 32 is provided on the reflecting sheet 10 side, an electric field can be applied to the conductive liquid 21 swiftly, thereby increasing the moving speed of the conductive liquid 21. Moreover, the moving speed of the conductive liquid 21 can be increased as above, such that moving display can be achieved and an image display provided with the compact display portion that has an excellent displaying function can be structured easily.

Moreover, in the present embodiment, since the upper-side upper electrode 30A is provided so as to cover the upper space 11 on the display surface side, the electric field to be applied to the conductive liquid 21 can be increased easily, so that the moving speed of the conductive liquid 21 can be improved easily.

Moreover, in the present embodiment, since the lower electrode 32 is provided on a surface, which faces the through hole 15, of the reflecting sheet 10, the electric field to be applied to the conductive liquid 21 can be increased easily, so that the moving speed of the conductive liquid 21 can be increased easily.

Moreover, in the present embodiment, since the upper end opening (one end side) of the through hole 15 is connected with the central portion of the upper space 11, the movement of the conductive liquid 21 from the through hole 15 toward the peripheral portion side of the upper space 11 and the movement of the conductive liquid 21 from the peripheral portion of the upper space 11 toward the through hole 15 side can be carried out at a uniform speed.

Moreover, in the present embodiment, since the back surface sheet is structured to include the reflecting sheet 10 and the lower electrode substrate (substrate sheet) 14, a structural strength of the display device can be enhanced easily. Further, since the liquid storage space is constituted of the through hole 15, the liquid storage space can be formed with higher precision.

Moreover, in the present embodiment, since the lower electrode substrate 14 is provided with the lower-side lower electrode 32A so as to close a lower end opening (other end side) of the through hole 15, the electric field to be applied to the conductive liquid 21 can be increased more easily, so that the moving speed of the conductive liquid 21 can be improved more easily.

### Embodiment 2

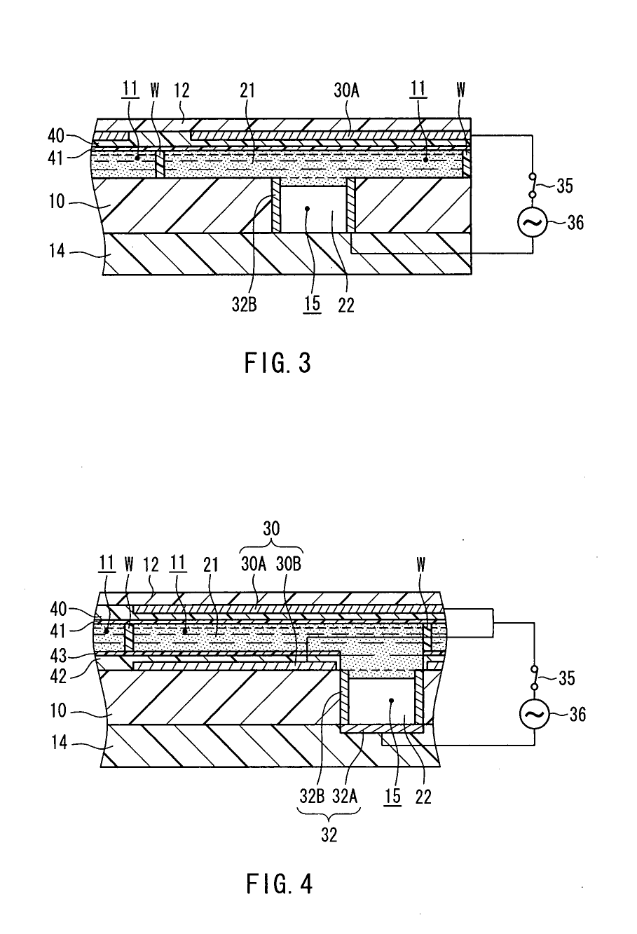

FIG. 3 is a cross-sectional view showing a configuration of a main part of a display device and an image display according to Embodiment 2 of the present invention. In the figure, a main difference between the present embodiment and Embodiment 1 described above lies in the provision of only an upper-side upper electrode and a cylindrical lower electrode. Incidentally, elements provided in common with Embodiment 1 described above are given the same reference numerals, and the redundant description thereof will be omitted here.

As shown in FIG. 3, on the upper space 11 side, the upper-side upper electrode 30A is provided only on a lower side of the upper electrode substrate 12. Whereas, on the through hole 15 side, only the cylindrical lower electrode 32B is provided in the reflecting sheet 10.

With the above-described configuration, in the present embodiment, similarly to Embodiment 1, the display color on the display surface side can be changed by moving the conductive liquid 21 toward the upper space 11 side or the through hole 15 side according to the operations of opening/closing the switch 35, thereby producing effects similar to those in Embodiment 1.

### Embodiment 3

FIG. 4 is a cross-sectional view showing a configuration of a main part of a display device and an image display according to Embodiment 3 of the present invention. In the figure, a main difference between the present embodiment and Embodiment 1 described above lies in that one end side of the through hole is connected with one end portion of the upper space. Incidentally, elements provided in common with Embodiment 1 described above are given the same reference numerals, and the redundant description thereof will be omitted here.

That is, as shown in FIG. 4, in the reflecting sheet 10, the through hole 15 is provided on one end side of the reflecting sheet 10 in the transverse direction, for example, on a right end side of the figure, and is connected with a right end portion of the upper space 11 in the figure so as to form the fluid flowing part having a L-shaped cross section.

With the above-described configuration, in the present embodiment, similarly to Embodiment 1, the display color on the display surface side can be changed by moving the conductive liquid 21 toward the upper space 11 side or the through hole 15 side according to the operations of opening/closing the switch 35, thereby producing effects similar to those in Embodiment 1. Moreover, in the present embodiment, since the through hole 15 is connected with the one end portion of the upper space 11, the conductive liquid 21 that flows in from the through hole 15 side flows in one direction of the transverse direction of the figure toward a left end portion side of the upper space 11 in the figure, when the conductive liquid 21 flows in toward the upper space 11 side. Similarly, when the conductive liquid 21 flows out from the upper space 11, the conductive liquid 21 flows from the upper space 11 side into the through hole 15 in a direction reverse to the transverse direction of the figure, and returns to the through hole 15 side. As a result, the conductive liquid 21 can be moved toward the upper space 11 side or the through hole 15 side smoothly.

### Embodiment 4

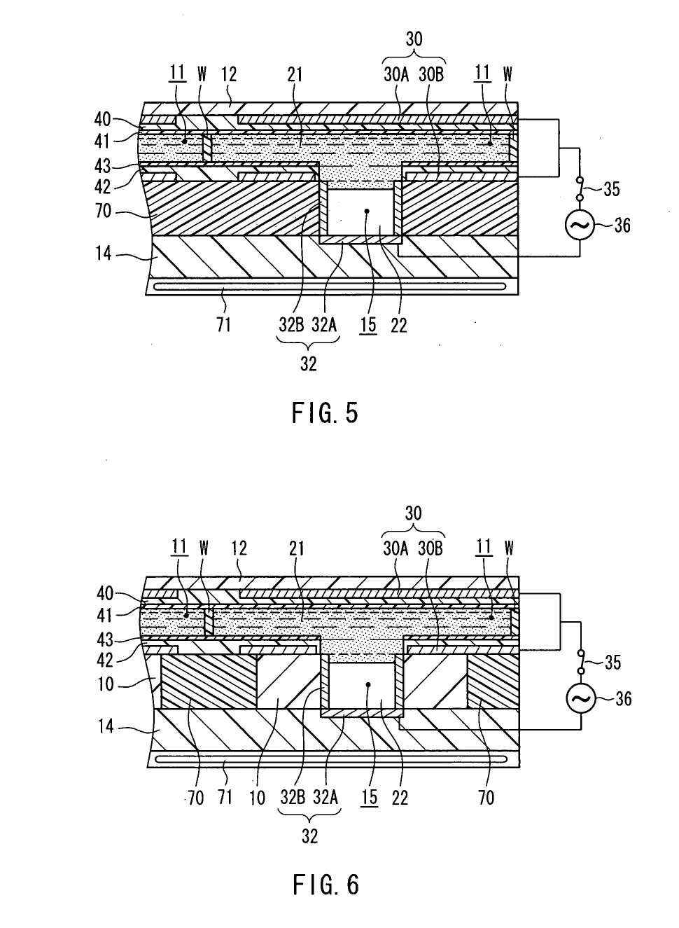

FIG. 5 is a cross-sectional view showing a configuration of a main part of a display device and an image display according to Embodiment 4 of the present invention. In the figure, a main difference between the present embodiment and Embodiment 1 described above lies in the provision of a transparent sheet instead of the reflecting sheet and the provision of a back light on a lower side of the lower electrode substrate. Incidentally, elements provided in common with Embodiment 1 described above are given the same reference numerals, and the redundant description thereof will be omitted here.

As shown in FIG. 5, in the present embodiment, a transparent sheet 70 is used as the intermediate sheet included in the above-described back surface sheet. The transparent sheet 70 is formed of a transparent PET resin similarly to the lower electrode substrate 14. Moreover, in the present embodiment, a back light 71 that emits white illumination light is provided on the lower side (back surface side) of the lower electrode substrate 14, and can perform an operation of lighting as necessary regardless of the operations of opening/closing the switch 35.

With the configuration described above, similarly to Embodiment 1, the present embodiment can change the display color on the display surface side by moving the conductive liquid 21 toward the upper space 11 side or the through hole 15 side according to the operations of opening/closing the switch 35, thereby producing effects similar to those in Embodiment 1. Also, in the present embodiment, since the display device of a transmission-type is constituted of providing the back light 71, the white display can be achieved by the illumination light from the back light 71, making it possible to carry out a suitable operation of display even when the external light is not sufficient or in the night time. Thereby, the display quality of the white display can be improved easily. Moreover, when achieving the color display by the conductive liquid 21, the illumination light from the back light 71 is irradiated, thereby improving the display quality of the color display easily.

Alternatively to the above description, by changing an emission color of the back light 71, it is possible to change the display color on the display surface side according to the emission color. Moreover, it is possible to change a brightness of the display device easily by using the back light 71, making it possible to easily structure the display device that has a wide dimming range and can perform a control of the gradation with high precision.

### Embodiment 5

FIG. 6 is a cross-sectional view showing a configuration of a main part of a display device and an image display according to Embodiment 5 of the present invention. In the figure, a main difference between the present embodiment and Embodiment 1 described above lies in the provision of a reflecting sheet and a transparent sheet in parallel and the provision of a back light on a lower side of the lower electrode substrate. Incidentally, elements provided in common with Embodiment 1 described above are given the same reference numerals, and the redundant description thereof will be omitted here.

As shown in FIG. 6, in the present embodiment, the reflecting sheet 10 and the transparent sheet 70 are used as an intermediate sheet included in the back surface sheet, and are provided in parallel in the transverse direction in the figure. More specifically, as shown in FIG. 6, the reflecting sheet 10 is disposed in the central portion of the pixel region, and the transparent sheet 70 formed of a transparent PET resin is disposed in a peripheral portion of the pixel region so as to sandwich the reflecting sheet 10 in the transverse direction described above. Moreover, in the present embodiment, the back light 71 that emits white illumination light is provided on the lower side (the back surface side) of the lower electrode substrate 14, and can carry out the operation of lighting as necessary, regardless of the operations of opening/closing the switch 35.

With the configuration described above, similarly to Embodiment 1, the present embodiment can change the display color on the display surface side by moving the conductive liquid 21 toward the upper space 11 side or the through hole 15 side according to the operations of opening/closing the switch 35, thereby producing effects similar to those in Embodiment 1. Also, in the present embodiment, since the reflecting sheet 10, the transparent sheet 70 and the back light 71 are provided so as to constitute the semitransparent display device, the white display can be achieved by the reflected light of the external light resulting from the reflecting sheet 10 and the illumination light from the back light 71, making it possible to achieve a suitable operation of display. Thereby, the display quality of the white display can be improved easily. Moreover, since the external light can be used besides the back light 71, it is possible to reduce the power consumption of the back light 71. Alternatively to the above description, a configuration where the transparent sheet 70 and the reflecting sheet 10 are respectively disposed in the central portion and the peripheral portion of the pixel region may also be applied.

### Embodiment 6

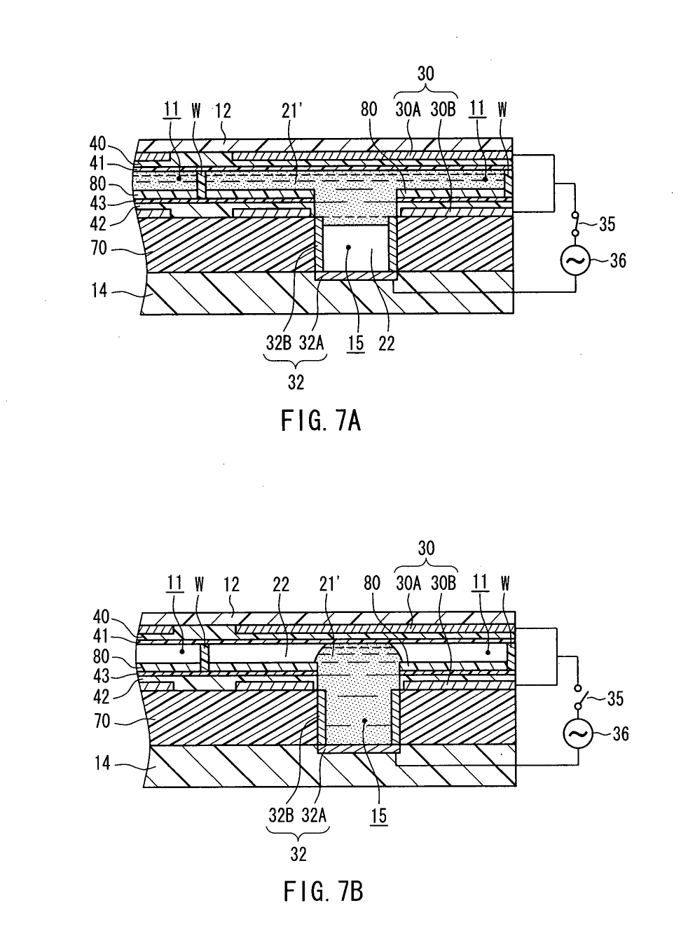

FIG. 7A is a cross-sectional view showing a configuration of a main part of a display device and an image display according to Embodiment 6 of the present invention, and FIG. 7B is a view for explaining a state of an operation of the display device and the image display according to the present embodiment in a case where the switch shown in FIG. 7A is OFF. In the figures, a main difference between the present embodiment and Embodiment 1 described above lies in that light-scattering particles are mixed into the conductive liquid, a transparent sheet is provided instead of the reflecting sheet, and colored layers in predetermined colors are provided on a surface side of the transparent sheet on the upper space side. Incidentally, elements provided in common with Embodiment 1 described above are given the same reference numerals, and the redundant description thereof will be omitted here.

As shown in FIG. 7, a conductive liquid 21′ of the present embodiment is not a colored liquid that is colored in a predetermined color but is a light-scattering liquid. More specifically, no pigment or the like is added into the conductive liquid 21′, but light-scattering particles such as titanium oxide particles and hollow particles are mixed therein, so that the conductive liquid 21′ is made the light-scattering liquid that scatters and reflects the external light. Moreover, in the present embodiment, the transparent sheet 70 is used as the intermediate sheet included in the above-described back surface sheet. The transparent sheet 70 is formed of a transparent PET resin similarly to the lower electrode substrate 14. Further, on a surface of the transparent sheet 70 on the display surface side, the colored layers 80 in the predetermined colors are provided so as to be contact with the upper space 11.

With the configuration described above, similarly to Embodiment 1, the present embodiment can change the display color on the display surface side by moving the conductive liquid 21′ toward the upper space 11 side or the through hole 15 side according to the operations of opening/closing the switch 35, thereby producing effects similar to those in Embodiment 1. Further, in the present embodiment, a time of the color display and a time of the white display on the display surface side differ from Embodiment 1. That is, at the time of the white display, the conductive liquid 21′ flows in toward the upper space 11 side while the switch 35 is ON, thereby achieving the white display with high quality due to the light-scattering effect of the conductive liquid 21′. Whereas, at the time of the color display, the conductive liquid 21′ returns to the through hole 15 side while the switch 35 is OFF, and the oil 22 flows in toward the upper space 11 side, thereby achieving the color display resulting from the colored layers 80.

Incidentally, oils colored in the predetermined colors can also be used instead of the colored layers 80. Moreover, it is also possible to adopt a configuration in which an upper surface of the transparent sheet on the display surface side is colored with a paint.

### Embodiment 7

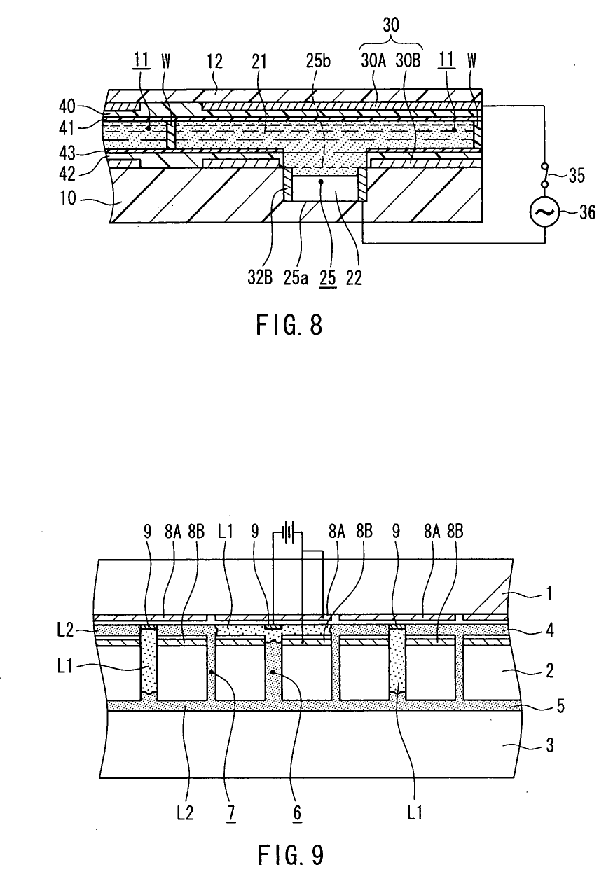

FIG. 8 is a cross-sectional view showing a configuration of a main part of a display device and an image display according to Embodiment 7 of the present invention. In the figure, a main difference between the present embodiment and Embodiment 1 described above lies in the provision of a recessed portion instead of the through hole in the reflecting sheet, and the omission of the provision of the lower electrode substrate. Incidentally, elements provided in common with Embodiment 1 described above are given the same reference numerals, and the redundant description thereof will be omitted here.

That is, as shown in FIG. 8, in the present embodiment, a recessed portion 25 whose one end side is connected with the central portion of the upper space 11 is formed at a central portion of the reflecting sheet 10. More specifically, the recessed portion 25 constitutes the above-described liquid storage space with a bottom, and an upper end opening 25b is connected with the upper space 11. Moreover, in the recessed portion 25, a lower end 25a side is constituted of the surface of the reflecting sheet 10. Thereby, in the present embodiment, unlike each of the above-described embodiments, the display device can be structured without providing the lower electrode substrate 14. Alternatively to the above description, a second electrode may be provided on the surface of the reflecting sheet 10 on the lower end 25a side.

With the configuration described above, similarly to Embodiment 1, the present embodiment can change the display color on the display surface side by moving the conductive liquid 21 toward the upper space 11 side or the through hole 15 side according to the operations of opening/closing the switch 35, thereby producing effects similar to those in Embodiment 1. Moreover, in the present embodiment, since the display device is structured without providing the lower electrode substrate 14, the display device and the image display that have the small number of the components and simple configurations can be structured more easily.

It should be noted that the above-described embodiments are all illustrative and not limiting. The technical scope of the present invention is defined by the claims, and all changes within the range equivalent to the configurations recited therein also are included in the technical scope of the present invention.

For example, although the above description has been directed to the case of applying the present invention to an image display including a display portion that can display a color image, the present invention can be used in any electronic apparatuses provided with a display portion for displaying information containing a character and an image without any particular limitation. The present invention can be used in a preferred manner in various electronic apparatuses including a display portion, for example, personal digital assistants (PDAs) such as electronic personal organizers, displays attached to personal computers and TV sets, and electronic papers.

Also, although the above description has been directed to the case of constituting the display surface including display spaces for individual primary colors of R, G and B, the present invention is not limited to this as long as a plurality of display spaces are provided respectively for a plurality of colors allowing a full color display on the display surface side. More specifically, display spaces in which conductive liquids colored respectively in cyan (C), magenta (M) and yellow (Y) are sealed are provided instead of the display spaces for R, G and B described above, thus constituting the display spaces for individual colors of C, M and Y. However, in the case of constituting the display spaces for C, M and Y, it is more preferable to provide a display space for black having a conductive liquid colored in black because the display quality of black display may deteriorate compared with the case of R, G and B. Furthermore, it also is possible to use colored (conductive) liquids colored in predetermined colors corresponding to combinations of a plurality of colors that can display a color image on the display surface other than R, G, B and C, M, Y, for example, R, G, B, Y, C five colors), R, G, B, C (four colors), R, G, B, Y (four colors), G, M (two colors), etc.

Moreover, the above description has been directed to the case of using the ionic liquid as the conductive liquid, but the conductive liquid of the present invention is not limited to this, and for example, alcohol, acetone, formamide, ethyleneglycol, water or a mixture thereof may also be used as the conductive liquid.

Further, the above description has been directed to the case of using the nonpolar oil, but the present invention is not limited to this, any insulating fluid that does not blend in the conductive liquid may be used, and for example, an air may be used instead of the oil 22. Moreover, a silicone oil, an aliphatic hydrocarbon and the like can be used as the oil. Incidentally, as the above-described embodiments, in the case of using the nonpolar oil that is not compatible with the ionic liquid, a liquid drop of the ionic liquid moves in the nonpolar oil more easily than in the case of using the air and the ionic liquid, and it is possible to move the ionic liquid (conductive liquid) at a high speed, thus being preferable because the display color can be switched at a high speed.

Further, the above description has been directed to the case of providing the upper electrode (first electrode) on a surface of a sheet such as the upper electrode substrate, but the present invention is not limited to this, and may also use the first electrode that is buried into an inside of the sheet made of the insulating material. In the case of structuring as described above, the provision of the dielectric layer can also be omitted. Moreover, the first electrode may be provided on the surface side of at least one of the transparent sheet and the back surface sheet on the display space side, and may be provided only on the reflecting sheet side, for example.

Alternatively to the above description, instead of the through hole, a rectangular liquid storage space having a rectangular-shaped cross section can also be used. Also, the liquid storage space can be constituted of the two or more through holes.

Moreover, the above description has been directed to the case of using the alternating-current power supply, but instead of the alternating-current power supply, a direct-current power supply can be used to be included in the driver, similarly to the conventional example shown in FIG. 9.

### INDUSTRIAL APPLICABILITY

The display device and the electric apparatus using the same according to the present invention can increase the moving speed of the conductive liquid that is moved by the electrowetting phenomenon with a simple configuration and can provide a compact device structure, thereby being effective to the display device that can display moving images.

1. A display device comprising:
a transparent sheet provided on a display surface side;
a back surface sheet provided on a back surface side of the transparent sheet such that a predetermined display space is formed between the transparent sheet and the back surface sheet, and such that a liquid storage space whose one end side is connected with the display space is formed;
a transparent first electrode provided on a surface side of at least one of the transparent sheet and the back surface sheet on the display space side;
a second electrode provided in the back surface sheet so as to surround the liquid storage space;
a conductive liquid sealed into an inside of a liquid flowing part formed of the display space and the liquid storage space so as to be movable toward the display space side or the liquid storage space side; and
a driver having a switch and a power supply connected between the first electrode and the second electrode, and for changing a display color on the display surface side by moving the conductive liquid toward the display space side or the liquid storage space side according to operations of opening/closing the switch.

2. The display device according to claim 1, wherein the first electrode is provided so as to cover the display surface side of the display space.

3. The display device according to claim 1, wherein the second electrode is provided on a surface, which faces the liquid storage space, of the back surface sheet.

4. The display device according to claim 1, wherein one end side of the liquid storage space is connected with a central portion of the display space.

5. The display device according to claim 1, wherein one end side of the liquid storage space is connected with one end portion of the display space.

6. The display device according to claim 1, wherein a dielectric layer is laminated on a surface of the first electrode or the second electrode on the display space side.

7. The display device according to claim 1, wherein the back surface sheet comprises:
an intermediate sheet whose one surface is provided on the display space side, and which has a through hole whose one end side is connected with the display space so as to constitute the liquid storage space; and
a substrate sheet that is provided on a back surface side of the intermediate sheet so as to seal the other end side of the through hole.

8. The display device according to claim 7, wherein the second electrode is provided in the substrate sheet so as to close the other end side of the through hole.

9. The display device according to claim 7, wherein
the conductive liquid is made of a colored liquid that is colored in a predetermined color,
a transparent insulating fluid that does not blend in the conductive liquid is sealed into the inside of the liquid flowing part so as to be movable toward the display space side or the liquid storage space side,
the intermediate sheet is constituted of a reflecting sheet, and
the driver moves the conductive liquid and the insulating fluid toward the display space side and the through hole side, respectively, so as to change the display color on the display surface side into the predetermined color, and moves the insulating fluid and the conductive liquid toward the display space side and the through hole side, respectively, so as to change the display color on the display surface side into white.

10. The display device according to claim 9, wherein the reflecting sheet comprises: a transparent polymeric resin; and plural kinds of fine particles that are added into an inside of the polymeric resin and have different refractive indices.

11. The display device according to claim 7, wherein
the conductive liquid is made of a colored liquid that is colored in a predetermined color,
a transparent insulating fluid that does not blend in the conductive liquid is sealed into the inside of the liquid flowing part so as to be movable toward the display space side or the liquid storage space side,
the intermediate sheet and the substrate sheet is constituted of a transparent sheet,
a back light is provided on a back surface side of the substrate sheet, and
the driver moves the conductive liquid and the insulating fluid toward the display space side and the through hole side, respectively, so as to change the display color on the display surface side into the predetermined color, and moves the insulating fluid and the conductive liquid toward the display space side and the through hole side, respectively, so as to change the display color on the display surface side into white.

12. The display device according to claim 7, wherein
the conductive liquid is made of a colored liquid that is colored in a predetermined color,
a transparent insulating fluid that does not blend in the conductive liquid is sealed into the inside of the liquid flowing part so as to be movable toward the display space side or the liquid storage space side,
the intermediate sheet includes a reflecting sheet and a transparent sheet that are provided in parallel,
the substrate sheet is constituted of a transparent sheet,
a back light is provided on a back surface side of the substrate sheet, and
the driver moves the conductive liquid and the insulating fluid toward the display space side and the through hole side, respectively, so as to change the display color on the display surface side into the predetermined color, and moves the insulating fluid and the conductive liquid toward the display space side and the through hole side, respectively, so as to change the display color on the display surface side into white.

13. The display device according to claim 7, wherein
light-scattering particles are mixed into the conductive liquid,
a transparent insulating fluid that does not blend in the conductive liquid is sealed into the inside of the liquid flowing part so as to be movable toward the display space side or the liquid storage space side,
a colored layer in a predetermined color is provided on a surface side of the intermediate sheet on the display space side, and
the driver moves the conductive liquid and the insulating fluid toward the display space side and the through hole side, respectively, so as to change the display color on the display surface side into white, and moves the insulating fluid and the conductive liquid toward the display space side and the through hole side, respectively, so as to change the display color on the display surface side into the predetermined color.

14. The display device according to claim 1, wherein a plurality of the display spaces are provided respectively for a plurality of colors allowing a full color display on the display surface side.

15. An electric apparatus comprising a display portion for displaying information containing a character and an image, wherein the display device according to claim 1 is used for the display portion.
